(19) United States
(12) Patent Application Publication
(10) Pub. No.: US 2007/0165618 A1
(43) Pub. Date: Jul. 19, 2007

(54) Vertical Network Switch

(76) Inventors: Eren Niazi, San Jose, CA (US); Marc Rotzow, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/623,436

(22) Filed: Jan. 16, 2007

Related U.S. Application Data
(60) Provisional application No. 60/759,866, filed on Jan. 18, 2006.

(51) Int. Cl. H04L 12/50

(52) U.S. Cl. 370/360

(57) ABSTRACT

A network switch is provided whereby the vertical dimension of the network switch is larger than the horizontal dimension of the network switch. The network switch is further capable of being mounted vertically on a server rack. Further, the network switch comprises a controller module and a power supply module allowing the network switch to route incoming data to a receiving location. Using the vertical network switch reduces cable length, simplifies layout, increases port density, improves the appearance of the server rack and reduces the overall cost of operating the vertical network switch and network.

### RELATED APPLICATION

This application claims a benefit of, and priority under 35 USC §119(e) to U.S. Provisional Patent Application No. 60/759,866 filed on Jan. 18, 2006, the content of which is hereby incorporated by reference in its entirety.

### TECHNICAL FIELD

This invention relates to network switches for computer systems, and more particularly to a manner in which network switches are laid out.

### BACKGROUND

A network switch is generally an interconnected plurality of network ports contained together in a housing. The plurality of network ports connect incoming and outgoing lines of a Local Area Network (LAN) or other communication, electronic, or electrical system. Network switches generally also include a power supply to power the switch and a command module to route the incoming lines to the outgoing lines. In a LAN, the network switch connects the network's computers to each other and to outside lines enabling the LAN to connect to the Internet or another Wide Area Network (WAN). Connections to the network switch are made using patch cords and ports. This allows circuits to be reconfigured by modifying the patch cord connections.

While a network switch may be used in a telecommunications closet or in other environments, it is more commonly found within the environs of a data center. The network switch commonly connects servers on a rack mount to the Internet, to other switches or to other devices using a Registered Jack-45 jack (RJ-45 jack). The RJ-45 jack is an eight-wire connector commonly used to connect computers onto a LAN, commonly using an Ethernet connection.

Existing network switches route incoming and outgoing data using Layers 2 and optionally Layers 3-4 of the Open System Interconnection (OSI) model. The OSI model defines a seven-layer networking for implementing network protocols. The seven layers are: physical, data link, network, transport, session, presentation and application. Control passes from one layer to the next, starting at the application, or highest, layer and proceeding to the bottom, or physical, layer in one station where the protocol is transmitted to another device. The receiving device then examines the lowest, or physical, layer and incrementally passes control to the application level.

Many servers, computers, or other equipment to be connected via a network switch are provided as rack-mountable devices. Commonly, servers are provided as 19-inch wide equipment that can be mounted on 19-inch wide racks (server racks) such as the Electronic Industries Alliance 310-D, the International Electrotechnical Commission 60297 and the Deutsches Institut für Normung 41494 SC48D. Various devices are designed to be placed in racks, and such equipment is commonly described as rack-mount, rack-mounted systems, rack mount chassis, sub-rack, shelf, and similar terms.

Conventional server racks typically have heights ranging from 77 inches to 84 inches, widths ranging from 19 inches to 28 inches and depths ranging from 24 inches to 42 inches. However, various other dimensions can be used for different applications or situations.

Typically, racks use two parallel metal strips (also referred to as “rails”) for mounting fixtures. Generally, for commonly-used rack sizes, the strips are each 0.625 inches (15.875 mm) wide, and are separated by a gap of 17.75 inches (450.85 mm), giving an overall rack width of 19 inches (482.6 mm). The strips generally have holes in them at regular intervals to create a horizontal pair of holes with a center-to-center distance of approximately 18.3 inches (464.82 mm). These pairs of holes are generally arranged vertically in repeating sets of three, with the holes in each group having center-to-center separations of 0.5 inch (12.7 mm), 0.625 inch (15.875 mm), and 0.625 inch (15.875 mm). This pattern of three hole groups typically repeats every 1.75 inches (44.45 mm).

Server racks are generally also divided into regions, each 1.75 inches high, containing three complete hole pairs in a vertically symmetric pattern. The hole pairs are typically centered 0.25 inch (6.35 mm), 0.875 inch (22.225 mm), and 1.5 inch (38.1 mm) from the top or bottom of the region. Such a region is commonly described as a “unit” or “U,” which is used to describe heights within the server rack. Rack-mountable equipment is generally designed to occupy some integral number of units, such as 1U or 2U.

Rack-mountable equipment is mounted simply by bolting its front panel to the rack, or with a square-holed rack by clipping or some other variation on the theme. Having all the structural support at one edge of the equipment is a weakness of this system, and so heavier equipment is designed to use a second pair of mounting strips located at the back of the equipment. Various spacing between the front and back strips are used; 800 mm is typical, and equipment is often designed to handle a range of rack depths.

FIG. 1 shows a conventional horizontal network switch 100 mounted on a server rack 110. Existing network switches are horizontal and require approximately 1U to accommodate 24-48 ports of connections. In FIG. 1, two horizontal network switches 100 are illustrated, as each horizontal network switch 100 is 1U high, 2U of space are occupied by the horizontal network switches 100. Underneath the horizontal network switches 100 are 38 servers 115, each 1U high. FIG. 1 also shows cables 120 used to connect the servers 115 to the horizontal network switches 100.

The cables 120 used to connect the horizontal network switches 100 to the servers 115 have various lengths. Servers 130 positioned on the server rack 110 farther away from the horizontal network switches 100 require longer cables 120. Thus, use of horizontal network switches 100 requires the use of varying cable lengths to connect servers 115 to the horizontal network switches 100. Typically, the shortest cable 120 length will be three feet for servers, or other equipment, closest to the horizontal network switch 100 while the longest cable 120 length will be fourteen feet for servers, or other equipment, farthest from the horizontal network switch 100. Further, proper “cleaning” or the cables 120 requires that the cables are routed through cable runs, down the side or the server rack 110 and to the horizontal network switch 100. Generally, the cable runs are approximately three feet and services only the servers closest to the horizontal network switch 100. As cabling 120 proceeds farther from the horizontal network switch 100, cable 120 length increases. Since a standard rack is about seven feet, to go from the top horizontal network switch 100 to the farthest server 115, or other device, at minimum 10 feet of cable 120 is needed. Further, some servers have cable runs mounted to the back of them so that a server mounted on server rails may be pulled out from the front without disconnecting the cables; they require an additional four or five additional feet of cable. This variable cable 120 length can require an additional 2U for cable runs or spacers necessary to route the cables.

Currently, mounting kits allow small horizontal network switches 100 to be mounted vertically, but these mounting kits cannot accommodate network switches over 19 inches long. Because horizontal network switches 100 are commonly used in environments with many network devices, these conventional mounting kits are ineffective.

### SUMMARY

In an embodiment, changing the layout of the network switch from horizontal to vertical and spanning the length of the server rack simplifies the layout of the switch. The access to ports is moved closer to the servers. Shorter cabling can be used, providing an overall cost savings as well as aesthetic benefits. In an embodiment, the network switch comprises a modular box having a plurality of network ports for ingoing and outgoing lines of a communications system. The modular box has a vertical dimension that is greater than a horizontal dimension and includes a plurality of mounting holes oriented along the vertical length. Further, the modular box includes a command module adapted to communicate with the ingoing and outgoing lines and a power module for providing power.

In an embodiment, the network switch comprises a modular box having a vertical dimension that is greater than a horizontal dimension. The modular box also includes a plurality of mounting holes units oriented along the vertical dimension and, in some embodiments, includes a control module and a power supply module. The modular box is capable of being vertically mounted on a server rack.

In an embodiment, a method for connecting two or more devices mounted on a server rack is provided.

### BRIEF DESCRIPTION OF THE DRAWINGS

Each of the figures diagrammatically illustrates aspects of the invention. The illustrations provide examples of the invention as described herein. Combinations of the aspects of specific variations or combinations of the specific variations themselves are within the disclosure of this document.

FIG. 1 is a conventional horizontal network switch mounted on a server rack.

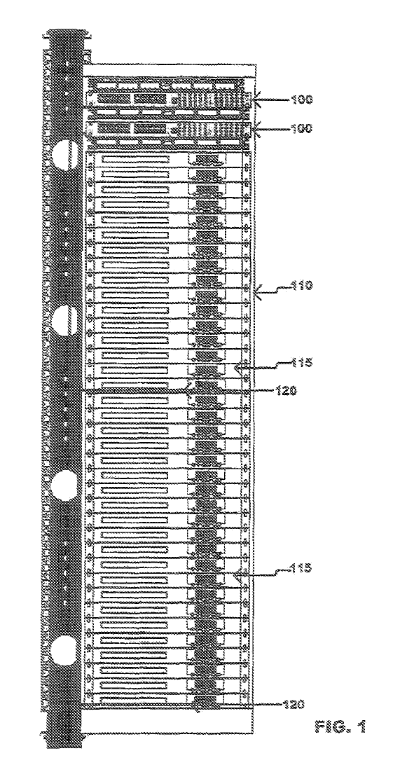

FIG. 2 is a front view of a vertical network switch according to one embodiment of the present invention.

FIG. 3 is a rear view of a vertical network switch including network ports according to one embodiment of the present invention.

FIG. 4 is a front view of a vertical network switch mounted to a server rack and connected to a plurality of servers according to one embodiment of the present invention.

### DETAILED DESCRIPTION

A vertical network switch, according to certain embodiments of the present invention, includes a plurality of network ports in a vertically oriented panel, a control module and a power supply module. In some embodiments, the power supply module and/or the control modules are sold or shipped separately from the other parts of the switch. The network switch can be mounted vertically on the side of a server rack such that the switch can service all of the servers, or other devices, in the server rack. Mounting the network switch vertically along the length of the server rack simplifies cabling by moving the ports closer to the servers or other devices. This reduced distance requires shorter cabling for connections, providing a cost savings, space savings, and aesthetic improvement. Furthermore, the vertical network switch can include more network ports than conventional network switches, increasing the port density while also conserving space in the server rack.

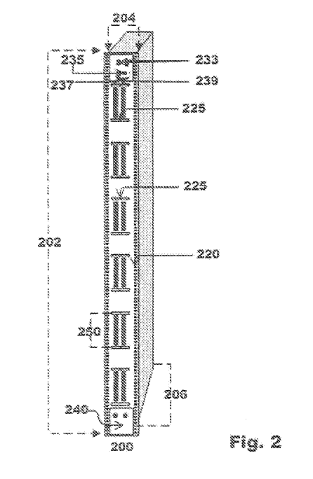

FIG. 2 shows a front view of the vertical network switch 200 according to one embodiment of the invention. All dimensions provided in this application are merely examples and the dimensions may vary within the scope of the invention, as will be apparent to one skilled in the art. For purposes of illustrations, the example measurements provided are represented in inches.

The vertical dimension 202 of the vertical network switch 200 exceeds the horizontal dimension 204. The depth 206 of the vertical network switch 200 may vary depending on the use of the vertical network switch 200. In an embodiment, the depth 206 is 12 inches, but the depth 206 may be altered to reduce the space occupied by the vertical network switch 200. In one embodiment, the vertical dimension 202 is approximately equal to the height of a server rack. For example, the vertical dimension 202 can be 72 inches, allowing the vertical dimension 202 to approximate the height of a server rack, such as the Electronic Industries Alliance 310-D or the International Electrotechnical Commission 60297. In an embodiment, the horizontal dimension 204 is 6.5 inches, although the horizontal dimension 204 can vary, with smaller horizontal dimensions 204 reducing the space occupied by the vertical network switch 204.

On the right and left sides of the vertical network switch 200 are a series of oval holes 200 running along the vertical dimension 202. In one embodiment, there are 123 oval holes 220 on the vertical network switch 200. For example, the holes 220 in the strips may be arranged vertically in repeating sets of three, with center-to-center separations of 0.5 inch (12.7 mm), 0.625 inch (15.875 mm), 0.625 inch (15.875 mm). Thus, the hole pattern repeats every 1.75 inches (44.45 mm). The preceding descriptions are merely examples, and the number of holes 220 and the pattern of repetition can vary according to different embodiments of the invention.

In an embodiment, server racks are divided into regions, 1.75 inches in height, with each region constituting a “unit,” or “U.” The holes 220 may be configured so that three complete pairs of holes in a vertically symmetric pattern are located in each region. For example, the hole 220 pairs may be centered 0.25 inch (6.35 mm), 0.875 inch (22.225 mm), and 1.5 inch (38.1 mm) from the top or bottom of the region. Such a region is commonly known as a “U”, for “unit”, and heights within server racks are commonly measured with this unit.

In an embodiment, the holes represent 41U (i.e. the height of 41 rack units). In an embodiment where the server rack has a vertical dimension of 42U, the vertical network switch 200 can be mounted to the server rack with 1U, or 1.75 inches, remaining at either the top or bottom of the server rack. Alternatively, the vertical network switch 200 can be mounted to one or more server racks. For example, the vertical network switch 200 can be mounted via holes 220 corresponding to the spacing of a single rack unit. This allows the vertical network switch 200 to be mounted on the side of the server rack. In another embodiment, the vertical network switch 200 can be mounted externally to the rack so the vertical network switch 200 does not take up space in the interior of the server rack. Mounting the vertical network switch 200 outside a server rack further allows the vertical network switch to be mounted between server racks.

A command module 230 implements network protocols to transmit data between network devices. In one embodiment, the command module 230 implements network protocols using the seven-layer Open System Interconnect (OSI) model to implement network protocols. For example, the command module 230 uses the data link layer (layer 2) to encode and decode received data packets, synchronize frames and check for errors. In alternative embodiments, the command module 230 may implement additional network functions such as routing, Transmission Control Protocol (TCP) offloading and/or load balancing. The command module 230 may implement these additional functions using the network layer, where Internet Protocol (IP) is used (layer 3) to route packets and the transport layer (layer 4) to perform error recovery and flow control.

Additional functionality for the command module 230 is possible if the session layer (layer 5), presentation layer (layer 6) and the application layer (layer 7) are used. Use of layers 5-7 enables the command module 230 to coordinate and manage connections between applications, format data for transmission between applications and provide application services for file transmission or other network software services. In an embodiment, the command module has layer 2-7 functionality to implement any or all of the above-described operations.

In an embodiment, the command module 230 comprises one or more Internet connection modules 233, such as a gigabyte Internet connection (GBIC) module, for connecting the vertical network switch 200 to another vertical network switch 200, a horizontal network switch 200, or another network device. The command module 230 may also include a network management interface 235 and/or a serial connection interface 237. In another embodiment, the command module 230 further includes a storage device 239, such as a flash memory card, a USB drive, or other suitable mass-storage device. The storage device 239 may preserve access lists or rules used by the command module 230 to implement layer 2-7 functionality.

Power module 240 provides power to the vertical network switch 200. In an embodiment, the power module 240 comprises two hot-swappable power supplies, which allows the operating time of the vertical network switch 200 to be increased. In other embodiments, the power module 240 may comprise additional power supplies, and may further include a battery. The power module 240 may use standard power connectors, without individual circuits, to power the vertical network switch 200.

This allows the panel to be mounted to the server rack with a distance of 1U or 1.75″ to be applied at either the top or bottom of the server rack. One may attach either the left or right side or both. This would be placed in between server racks.

The vertical network switch 220 further includes a plurality of rectangular slots 250 capable of containing a network interface, such as a network port. In one embodiment, the network switch 220 includes six rectangular slots 250, each measuring 5.50 inches high by 2½ inches wide.

In an embodiment, the vertical network switch 200 further includes cable guides 225 to accommodate different groups of network ports. For example, each group of network ports may be accompanied by a pair of cable guides 225, one at the top and bottom of each group of network ports. In one embodiment, the cable guide 225 is a metal rectangle measuring 3.75 inches in width, 0.25 inches in height and 3 inches in depth. For example, the distance between the front of the module and the cable guide 225 is 0.5 inches. The upper section of the cable guide 225 may also include a 0.75 inch angled gap, and cables may be run through a break in the cable guide. In one embodiment, the vertical network switch 200 includes twelve cable guides 225.

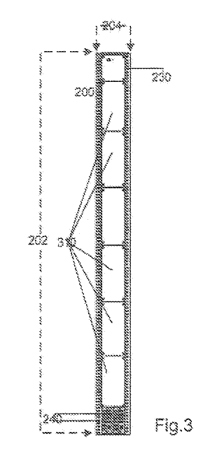

FIG. 3 shows a rear view of the vertical network switch 200 according to one embodiment of the invention. The illustration of FIG. 3 shows the vertical network switch divided into various regions 310. In one embodiment, the contents of the regions 310 may be varied according to network use. For purposes of illustration, FIG. 3 shows the vertical network switch 200 divided into multiple regions 310, although in other embodiments a different number of regions 310 may be used.

Depending on the number of network devices using the vertical network switch 200, each region 310 may contain a different number of network interface ports. In an embodiment, the number of network ports in each region 310 may be varied. This allows the capacity of the vertical network switch 200 to be modified in response to the number of network devices. In another embodiment, a region 310 may be inserted into or removed from the vertical network switch as a whole.

The rear of the command module 230 is essentially blank. Each region 310 includes switch modules, which are a plurality of network ports. In one embodiment, the regions 310 include a total of six switch modules. These modules plug into an internal backplane of the switch to connect to command module 230. The switch modules may include 10/100 Ethernet ports, 10/100/1000 Ethernet ports, or any other form of network interface. In an embodiment, the power supply module 240 is located at the top of the vertical network switch 200, and may include multiple power supplies. In one embodiment the power supplies used are hot-swappable.

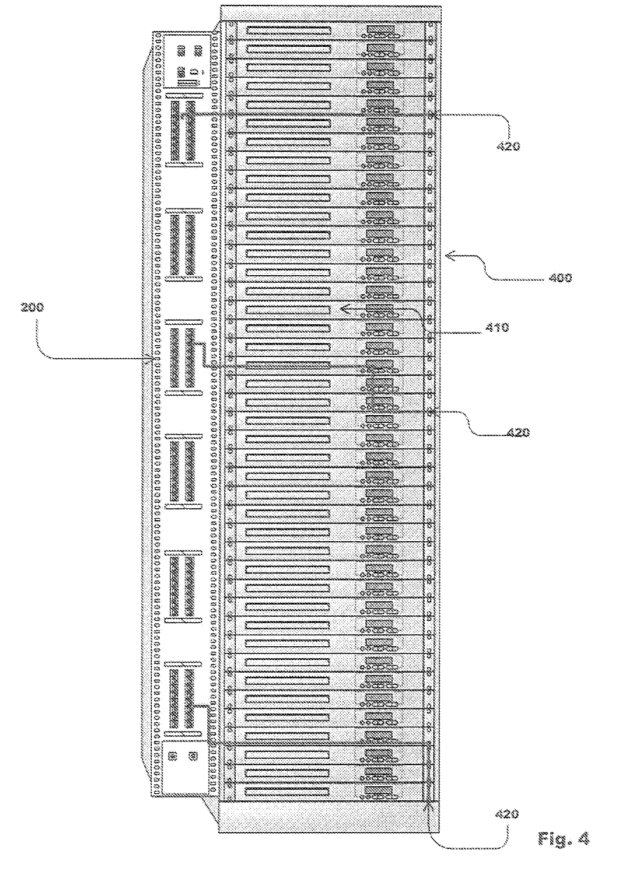

FIG. 4 shows a front view of a vertical network switch 200 mounted to a server rack 400 and connected to a plurality of servers 410 according to one embodiment of the present invention.

In server rack 400, 42 1U servers 410 are connected to the vertical network switch 200. Commonly used horizontal network switches 100 measure 4U in height. As many server racks 400 only have a height of 42U, use of horizontal network switches 100 only allows 38 1U servers to be included in the server rack 400. Thus, using the vertical network switch 200 rather than horizontal network switches 100 saves at least 4U in space within the server rack 400, which allows an additional 4 1U servers to be mounted in server rack 400.

FIG. 4 also shows cabling 420 connecting servers 410 within the server rack 400 to the vertical network switch 200. The lengths of the cables 420 are approximately equal regardless of the location of the server 410 within the server rack 400. In one embodiment, each server 410 requires approximately three feet of cable 200 to connect to vertical network switch 200. This reduces the amount of cabling 420, and associative cost, to connect servers 410, or other networked devices, to the vertical network switch 200.

Hence, using a vertical network switch 200 saves space within the server rack 400 and simplifies cabling 420. The vertical network switch 200 moves ports closer to the servers and removes the need for cables 420 of widely differing lengths. This reduces the overall cost for cables 420 by increasing the number of cables of the same length and reducing the overall amount of cable 420 necessary. Further, because the cables 420 are of similar lengths, there is an additional benefit of improving the aesthetics of the server rack 400. Additionally, in one embodiment the network ports included on the vertical network switch 200 may have a slanted orientation to further standardize the cable 420 lengths.

Additionally, the number of servers included within the server rack 400 is increased by using a vertical network switch 200. As the vertical network switch 200 is capable of being mounted on the side of the server rack 200, 4U of space in the server rack 400 is freed that would ordinarily be used for horizontal server racks 100.

Other utilizations of the vertical network switches 200 use RJ-45 jacks for additional functionality, such as keyboard use, video monitor use, mouse use, keyboard, video, mouse switch (KVM switch) use, or other functionality. The vertical network switch 200 may also allow support connections of management devices such as serial consoles or IPMI devices. The port density on the vertical network switch 200 allows for many possibilities in configuration and usage.

The shift from horizontal to vertical allows for savings in the total cost of ownership of the vertical network switch 200. By reducing cable lengths, by simplifying the layout, and increasing port density, the overall cost of ownership is significantly reduced. An additional aesthetic benefit is also provided by the symmetry of the cabling.

Upon review of the description and described embodiments of the present invention, those skilled in the art will understand that modifications and equivalent substitutions may be performed in carrying out the invention without departing from the scope of the invention. Thus, the invention is not meant to be limited by the embodiments explicitly described above, and is limited only by the following claims.

1. A network switch comprising:
a modular box having a plurality of network ports for ingoing and outgoing lines of a communications system, the modular box having a vertical dimension that is greater than a horizontal dimension and including a plurality of mounting holes for rack units oriented along the vertical length;
wherein the modular box is capable of being vertically mounted on a rack and is capable of servicing a plurality of rack units;
the modular box including a command module adapted to communicate with the ingoing and outgoing lines and a power module for providing power.

2. The network switch of claim 1, wherein the network switch comprises at least 96 network ports.

3. The network switch of claim 2, wherein the modular box comprises at least 4 separate sections, each section including at least 16 network ports.

4. The network switch of claim 1, wherein the plurality of network ports are RJ-45 jacks.

5. The network switch of claim 1, wherein the power module comprises at least one power supply unit.

6. The network switch of claim 5, wherein the power supply unit comprises a hot-swappable power supply.

7. The network switch of claim 1, wherein the command module determines an outgoing line for an incoming line.

8. The network switch of claim 7, wherein the command module comprises at least two network ports.

9. The network switch of claim 7, wherein the command module implements functions included in layers 2-7.

10. The network switch of claim 8, wherein the unit network ports comprise GBIC modules capable of connecting with a networked device.

11. The network switch of claim 1, wherein the modular box is mounted on an external vertical post of the rack.

12. The network switch of claim 1, wherein the panel is capable of being mounted to a single vertical post of a server rack.

13. The network switch of claim 1, wherein the plurality of network ports are in a vertical orientation.

14. The network switch of claim 1, wherein the plurality of network ports are in a slanted orientation.

15. The network switch of claim 1, wherein the modular box is capable of connecting two or more devices mounted in the rack through the plurality of network ports using cables having substantially similar lengths.

16. The network switch of claim 15, wherein the devices comprise servers having at least one network interface port.

17. The network switch of claim 1, further comprising one or more cable guides that are capable of redirecting one or more cables.

18. The network switch of claim 1, wherein the vertical dimension of the modular box is 72 inches and the horizontal dimension of the modular box is 5 inches.

19. A method for connecting two or more devices mounted on a server rack, the method comprising:
connecting one or more cables to a network switch having a plurality of network ports, wherein the network switch has a vertical dimension greater than a horizontal dimension, a plurality of mounting holes oriented along the vertical dimension, a command module and a power module; and
vertically mounting the network switch to the server rack for servicing a plurality of devices in the server rack.

20. The method of claim 19, wherein the network switch comprises at least 96 network ports.

21. The method of claim 20, wherein the network comprises at least 6 regions, each region including at least 16 network ports.

22. The method of claim 19, wherein the plurality of network ports comprise RJ-45 jacks.

23. The method of claim 19, wherein the network switch is mounted on an external portion of the server rack.

24. The method of claim 19, wherein the network switch is mounted to a single post of the server rack.

25. The method of claim 19, wherein the plurality of network ports are in a vertical orientation.

26. The method of claim 19, wherein the plurality of network ports are in a slanted orientation.

27. The method of claim 19, wherein the network switch is capable of connecting two or more devices mounted in the server rack through the plurality of network ports using cables having similar lengths.

28. The method of claim 27, wherein the devices comprise servers having at least one network interface port.

29. The method of claim 19, wherein the vertical dimension is 72 inches and the horizontal dimension is 5 inches.
